(19) United States
(12) Patent Application Publication
(10) Pub. No.: US 2022/0143853 A1
(43) Pub. Date: May 12, 2022

(54) Blade Adapter

(71) Applicants: Nelson Crandle, Prairieville, LA (US); Daryn Cook, Saint Amant, LA (US)

(72) Inventors: Nelson Crandle, Prairieville, LA (US); Daryn Cook, Saint Amant, LA (US)

(21) Appl. No.: 17/523,354

(22) Filed: Nov. 10, 2021

Related U.S. Application Data
(60) Provisional application No. 63/111,753, filed on Nov. 10, 2020.

(51) Int. Cl. B26B 19/38; B26B 19/06

(52) U.S. Cl. CPC B26B 19/3813; B26B 19/3846; B26B 19/06

(57) ABSTRACT

In accordance with objects of the invention, a blade adapter operable for attaching a blade assembly to an electric trimmer is provided. The blade adapter includes a base. A first plurality of holes is defined by the base and is operable to receive screws screwed into the electric trimmer. A second plurality of holes is defined by the base and is operable to receive and secure trimmer screws screwed through a static cutting blade of a blade assembly into the base. A channel is defined by the base and is operable to receive a cam adapter. A cam adapter has a drive connector opposite a blade engagement member. The drive connector is operable to engage a drive member of a motor of an electric trimmer. The blade engagement member is operable to engage and reciprocate a dynamic cutting blade of a blade assembly.

### CROSS-REFERENCE TO RELATED APPLICATIONS

This application is claims priority to U.S. Patent Application Ser. No. 63/111,753, filed Nov. 10, 2020, the entirety of which is incorporated by reference as if fully disclosed herein.

### BACKGROUND OF THE INVENTION

### Field of the Invention

The present invention relates generally to adapters for attaching blades to electric trimmers.

### General Background

Traditional electric trimmers for cutting hair and beards do not enable interchangeability of the blades, particularly with respect to attaching a high-end cutting blade to a standard electric trimmer. Barbers frequently have individual preferences for blades and electric trimmers. In some instances, the specific combination of preferential equipment is not available. Blades of high-end trimmers are typically the preference of barbers. However, high-end trimmers are expensive, which may be price prohibitive for some barbers. Accordingly, what is needed is an adapter for blades to attach to a variety of electric trimmers.

### SUMMARY OF THE INVENTION

In accordance with objects of the invention, a blade adapter operable for attaching a blade assembly to an electric trimmer is provided. The blade adapter includes a base. A first plurality of holes is defined by the base and is operable to receive screws screwed into said electric trimmer. A second plurality of holes is defined by the base and is operable to receive and secure trimmer screws screwed through a static cutting blade of a blade assembly into the base. A channel is defined by the base and is operable to receive a cam adapter. A cam adapter has a drive connector opposite a blade engagement member. The drive connector of the cam adapter is operable to engage a drive member of a motor of an electric trimmer. The blade engagement member of the cam adapter operable to engage and reciprocate a dynamic cutting blade of a blade assembly.

### BRIEF DESCRIPTION OF THE DRAWINGS

The foregoing and other objects, features, and advantages of the invention are apparent from the following detailed description taken in conjunction with the accompanying drawings in which like parts are given like reference numerals and, wherein:

FIG. 1 depicts an exploded view of a blade adapter operable to connect a blade assembly to an electric trimmer in accordance with embodiments of the invention.

FIG. 2 depicts a perspective view of a base of a blade adapter connected to an electric trimmer in accordance with embodiments of the invention.

FIG. 3 depicts a perspective view of a cam follower of a blade adapter connected to an electric trimmer in accordance with embodiments of the invention.

FIG. 4 depicts a bottom view of a cam follower connected to a reciprocating blade of a blade assembly in accordance with embodiments of the invention.

FIG. 5 depicts a reciprocating blade assembly attached to an electric trimmer by a blade assembly with a cam follower of a blade assembly engaged with a drive member of the electric trimmer in accordance with embodiments of the invention.

FIG. 6 depicts a front view of a base of a blade adapter in accordance with embodiments of the invention.

FIG. 7 depicts a side view of a base of a blade adapter in accordance with embodiments of the invention.

FIG. 8 depicts a top view of a base of a blade adapter in accordance with embodiments of the invention.

FIG. 9 depicts a front view of a cam follower of a blade adapter in accordance with embodiments of the invention.

FIG. 10 depicts a side view of a cam follower of a blade adapter in accordance with embodiments of the invention.

FIG. 11 depicts a perspective view of a cam follower of a blade adapter in accordance with embodiments of the invention.

FIG. 12 depicts a perspective view of a cam follower of a blade adapter in accordance with embodiments of the invention.

The images in the drawings are simplified for illustrative purposes and are not depicted to scale. Within the descriptions of the figures, similar elements are provided similar names and reference numerals as those of the previous figure(s). The specific numerals assigned to the elements are provided solely to aid in the description and are not meant to imply any limitations (structural or functional) on the invention.

The appended drawings illustrate exemplary configurations of the invention and, as such, should not be considered as limiting the scope of the invention that may admit to other equally effective configurations. It is contemplated that features of one configuration may be beneficially incorporated in other configurations without further recitation.

### DETAILED DESCRIPTION

The embodiments of the disclosure will be best understood by reference to the drawings, wherein like parts are designated by like numerals throughout. It will be readily understood that the components, as generally described and illustrated in the Figures herein, could be arranged and designed in a wide variety of different configurations or be entirely separate. Thus, the following more detailed description of the embodiments of the system and method of the disclosure, as represented in the Figures is not intended to limit the scope of the disclosure, as claimed, but is merely representative of possible embodiments of the disclosure.

The term “blade assembly” is used throughout this specification to mean a hair cutting implement that includes two blades, at least one of the blades being reciprocated with respect to the other blade under the influence of a drive member. The term “blade assembly” includes trimmers and any other devices that meet the foregoing general definition. The term “drive member” includes electric motors, magnetic drives, and pivot drives, the prime mover being operated by means of a power cord plugged into a power outlet or a battery or any other energy storage means.

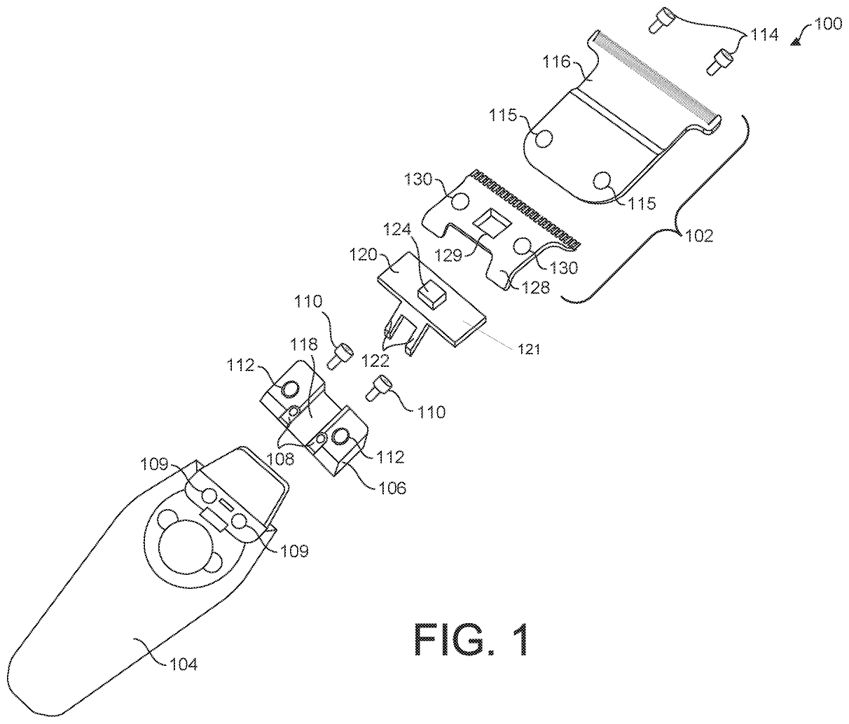

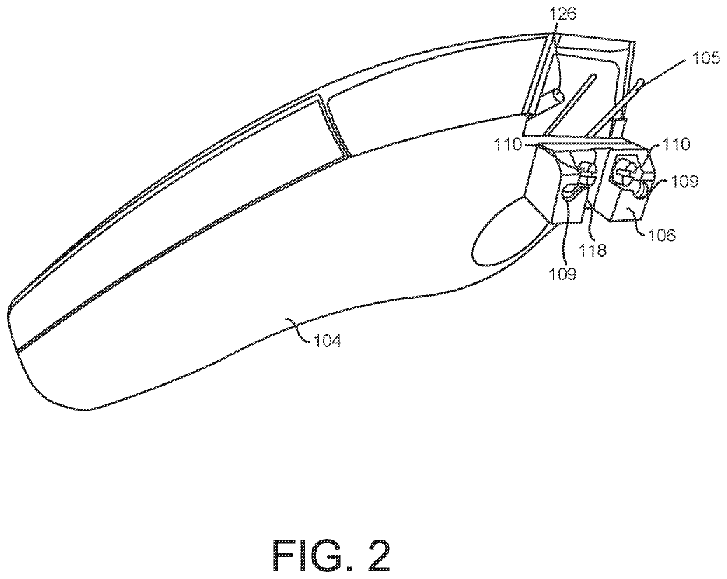

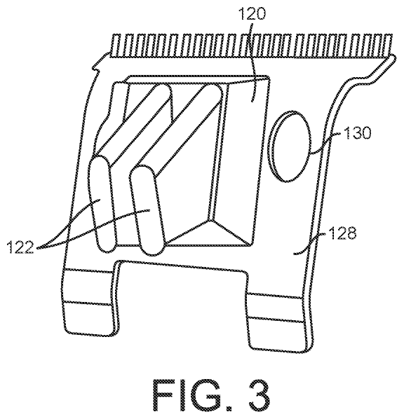

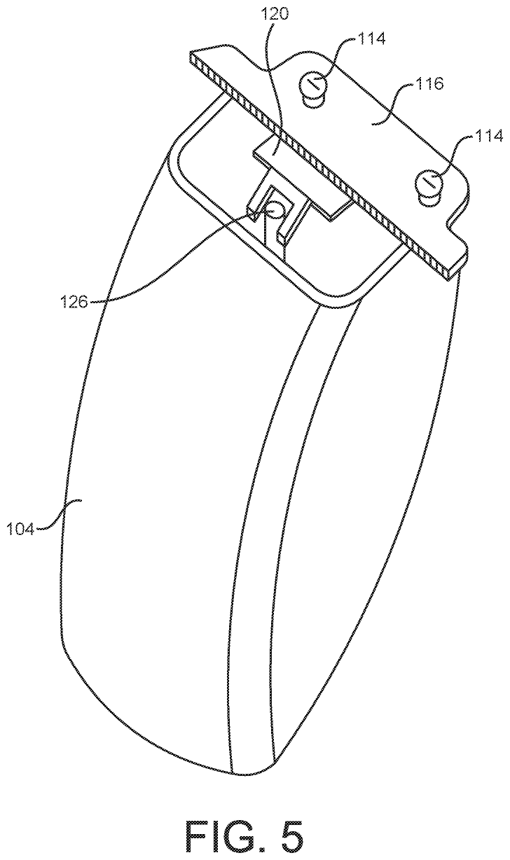

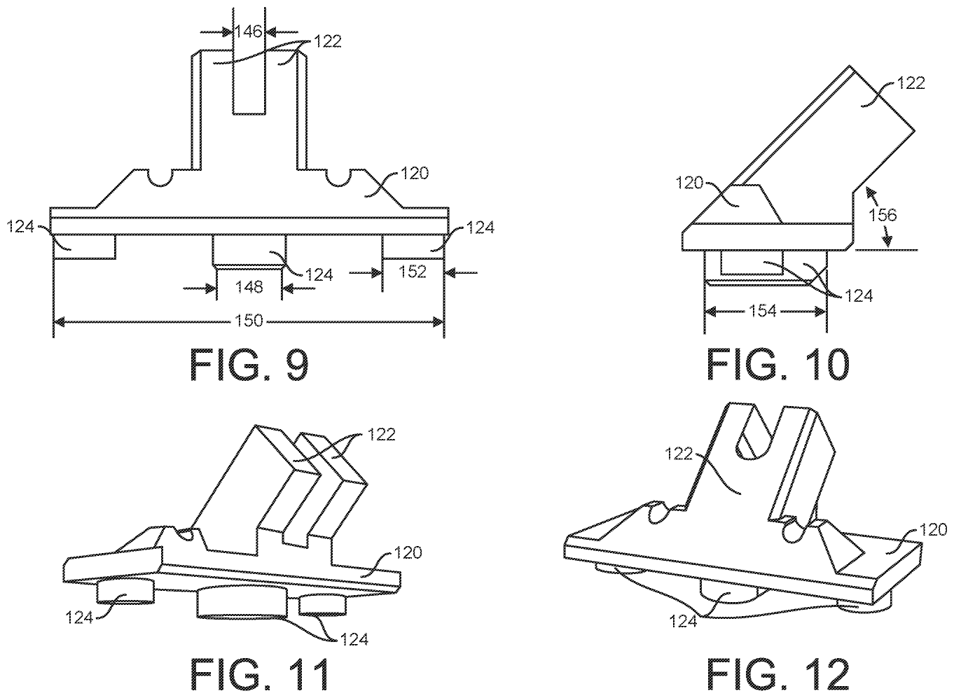

In accordance with embodiments of the invention, a blade adapter 100 operable for attaching a blade assembly 102 to an electric trimmer 104 is provided, as illustrated in FIGS. 1-12. The blade adapter 100 is operable to enable a blade assembly to be connected to a trimmer provided by a different manufacturer, enabling customization and cost savings if a user desires to attach an expensive blade assembly to an inexpensive trimmer. The blade adapter 100 includes a base 106. A first plurality of holes 108 are defined by the base 106 and are operable to receive trimmer screws 110 screwed into the electric trimmer 104 via threaded holes 109. The holes 118 on the base 106 are positioned to match the threaded holes 109 of an electric trimmer. The positioning of the holes 118 depends on the hole pattern of the electric trimmer. A second plurality of holes 112 is defined by the base 106 and is operable to receive and secure base screws 114 screwed through a first cutting blade 116 of a blade assembly 102 into the base 106. A channel 118 is defined by the base 106 and is operable to receive a cam adapter 120. The cam adapter 120 has a drive connector 122 positioned on a cam adapter base 121 opposite a blade engagement member 124. The drive connector 122 of said cam adapter 120 is operable to engage a drive member 126 (FIGS. 2 and 5) of a motor of the electric trimmer 104. As illustrated said drive connector 122 is a pair of parallel extrusions. The blade engagement member 124 of the cam adapter 120 is operable to engage and reciprocate a dynamic cutting blade 128 of a blade assembly 102. As illustrated in FIGS. 1-5, the blade engagement member 124 is a rectangular extrusion operable to fit within a rectangular receiving port 129 defined dynamic cutting blade 128. The shape of the engagement member 124 depends on the specific configuration of the dynamic cutting blade 128. As illustrated in FIGS. 9-12, the engagement member may be a plurality of extrusions operable to fit within a receiving port 129 and receiving holes 130 of a dynamic cutting blade 128.

In operation, a user will attach the base 106 to the electric trimmer 104 by screwing the trimmer screws 110 through the first plurality of holes 108 and into the trimmer 104. Next, the user will position the cam adapter 120 on an underside of the blade assembly 102 to engage the dynamic cutting blade 128 of the blade assembly 102. The user will then position the blade assembly 102 and cam adapter 120 onto a drive member 126 of the motor of the electric trimmer so that the driver connector 122 of the cam adapter 120 is engaged with and can be reciprocated by the drive member 126 and so that the cam adapter sits within the channel 118 of the base 106. Finally, the user will screw the base screws 114 through the static cutting blade 116 and into the second plurality of holes 112 in the base 106, securing the blade assembly 102 and the cam adapter 120 to the electric trimmer 104. A trimmer tension coil 105 (illustrated in FIG. 2) engages the underside of the blade assembly 102 to apply a force to assist in keeping the assembled blade adapter 100 and blade assembly 102 together.

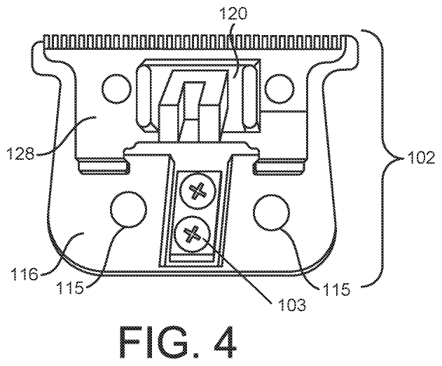

Embodiments of the invention enable versatility of blade and electric trimmer combination. The invention further enables an increased battery life of the electric trimmer, a higher RPM of the blade, added strength, prevents noise from developing over time, and prevents a lug of the trimmer over time. The cutting length of blade assembly 102 may be adjusted for by sliding the static cutting blade 116 relative to the dynamic cutting blade 128 and secured by blade assembly screws 103, as illustrated in FIG. 4.

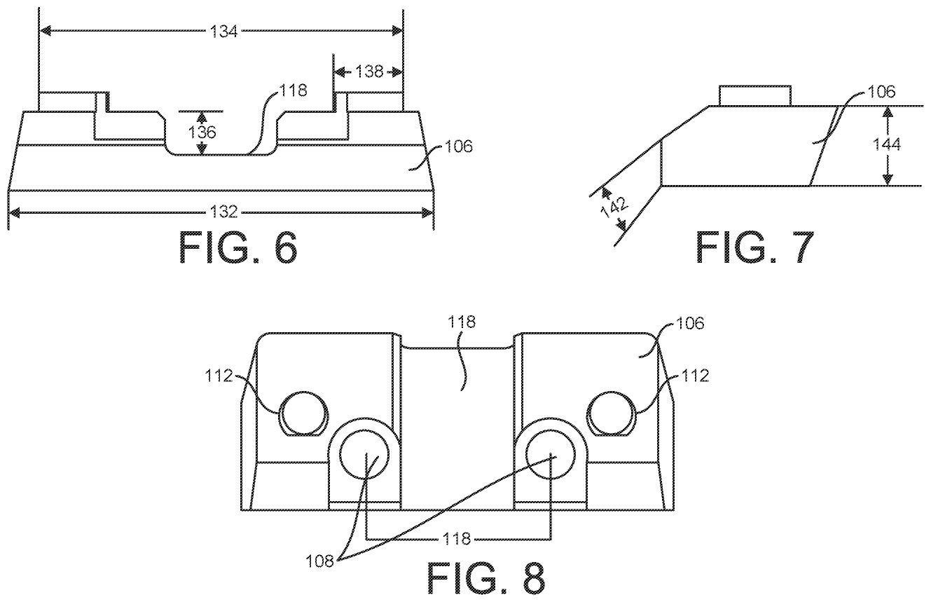

Referring to the embodiment of the base 106 illustrated in FIGS. 6-8, the base 106 may have a length 132 of 1.08 inches, a hole spacing 134 of 0.93-0.94 inches, a channel depth 136 of 0.11 inches, a hole width 138 of 0.18 inches, a base hole spacing 140 of 0.47 inches, an angle of 55 degrees, and a height 144 of 0.2 inches. The diameter of base holes 108 is 0.12 inches.

Referring to the embodiment of the cam follower 120 illustrated in FIGS. 9-12, the cam follower 120 may have a drive member width 146 of 0.08 to 0.09 inches, an engagement member width 148 of 0.18 inches, a length 150 of 0.96 inches, an engagement hole member width 154 of 0.15 inches, a width of 0.3 inches, and an angle 156 of 45 degrees between the drive member 146 and a cam adapter base 148.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A blade adapter operable for attaching a blade assembly to an electric trimmer, comprising:
a base;
a first plurality of holes defined by said base, said first plurality of holes operable to receive screws screwed into said electric trimmer;
a second plurality of holes defined by said base, said second plurality of holes operable to receive and secure trimmer screws screwed through a static cutting blade of a blade assembly into said base;
a channel defined by said base, said channel operable to receive a cam adapter; and
a cam adapter, said cam adapter having a drive connector opposite a blade engagement member, said drive connector of said cam adapter operable to engage a drive member of a motor of an electric trimmer, said blade engagement member of the cam adapter operable to engage and reciprocate a dynamic cutting blade of a blade assembly.

2. The blade assembly of claim 1, wherein said drive connector is a pair of parallel extrusions.

3. The blade assembly of claim 1, wherein said cam adapter:
a cam adapter base;
a drive connector, said drive connector attached to said base at an angle, said drive connector comprising a pair of parallel extrusions.

4. The blade assembly of claim 1, wherein said blade engagement member is an extrusion operable to fit within a receiving port defined by a dynamic cutting blade of a blade assembly.

5. The blade assembly of claim 1, wherein said blade engagement member comprises:
an extrusion operable to fit within a receiving port defined by a dynamic cutting blade of a blade assembly; and
a plurality of extrusions operable to fit within receiving holes defined by a dynamic cutting blade of a blade assembly.

6. A blade adapter operable for attaching a blade assembly to an electric trimmer, comprising:
a base;
a first plurality of holes defined by said base, said first plurality of holes operable to receive screws screwed into said electric trimmer;
a second plurality of holes defined by said base, said second plurality of holes operable to receive and secure trimmer screws screwed through a static cutting blade of a blade assembly into said base; and
a cam adapter, said cam adapter having a drive connector opposite a blade engagement member, said drive connector of said cam adapter operable to engage a drive member of a motor of an electric trimmer, said blade engagement member of the cam adapter operable to engage and reciprocate a dynamic cutting blade of a blade assembly.

7. The blade assembly of claim 6, wherein said drive connector is a pair of parallel extrusions.

8. The blade assembly of claim 6, wherein said cam adapter:
a cam adapter base;
a drive connector, said drive connector attached to said base at an angle, said drive connector comprising a pair of parallel extrusions.

9. The blade assembly of claim 6, wherein said blade engagement member is an extrusion operable to fit within a receiving port defined by a dynamic cutting blade of a blade assembly.

10. The blade assembly of claim 6, wherein said blade engagement member comprises:
an extrusion operable to fit within a receiving port defined by a dynamic cutting blade of a blade assembly; and
a plurality of extrusions operable to fit within receiving holes defined by a dynamic cutting blade of a blade assembly.
